(19) United States
(12) Patent Application Publication
(10) Pub. No.: US 2007/0019126 A1
(43) Pub. Date: Jan. 25, 2007

(54) Display device and method of manufacturing the same

(76) Inventors: Jung-Soo Rhee, Seoul (KR); Beohm-Rock Choi, Seoul (KR); Joon-Chul Goh, Suwon-si (KR)

Correspondence Address: MACPHERSON KWOK CHEN & HEID LLP, 2033 GATEWAY PLACE, SUITE 400, SAN JOSE, CA, 95110, US

(21) Appl. No.: 11/479,217

(22) Filed: Jun. 30, 2006

(30) Foreign Application Priority Data
Jul. 1, 2005 (KR) 2005-59059

(51) Int. Cl. G02F 1/1333; G02F 1/136; C09K 19/00

(52) U.S. Cl. 349/56; 349/43

(57) ABSTRACT

Disclosed is a display device including a substrate, a thin film transistor formed on the substrate, a first electrode connected to the thin film transistor, an organic layer formed on the first electrode, a second electrode formed on the organic layer, a protection layer formed on the second electrode, and a transparent layer formed on the protection layer. The protection layer absorbs ultraviolet ray and protects the organic layer from the ultraviolet ray. The protection layer is formed by an evaporation process and thus reduces the damage of the organic layer during formation of the protection layer. The protection layer also protects the organic layer during formation of the transparent layer.

### BACKGROUND OF THE INVENTION

(a) Field of the Invention

The present invention relates to a display device and a method of manufacturing the display device.

(b) Description of the Related Art

An organic light emitting device includes an anode, a cathode and an organic layer interposed between the anode the cathode. Electrons from the cathode and holes from the anode form excitons in the organic layer, and the organic layer illuminates by the energy emitted from the excitons.

Generally, the organic light emitting device is of two types, a passive matrix type and an active matrix type. The active matrix type organic light emitting device has a thin film transistor (hereinafter, referred to as TFT) as a switching device.

A process of manufacturing the active matrix organic light emitting device usually includes a TFT forming process, a bank section forming process, an organic layer forming process and a sealing process. During the organic layer forming process or the sealing process, ultraviolet ray is generated or used. The ultraviolet ray may damage the organic layer to deteriorate the display quality of the display device.

### SUMMARY OF THE INVENTION

A display device according to an embodiment of the present invention includes a substrate, a thin film transistor formed on the substrate, a first electrode connected to the thin film transistor, an organic layer formed on the first electrode, a second electrode formed on the organic layer, a protection layer formed on the second electrode and a transparent layer formed on the protection layer. The protection layer includes a material which is formed by an evaporation process. The protection layer includes a material that absorbs ultraviolet ray. The protection layer may include pentacene.

A display device according to another embodiment of the present invention includes a substrate, a gate electrode formed on the display substrate, a gate insulation layer formed on the gate electrode, a semiconductor layer formed on the gate insulation layer, an ohmic contact layer formed on the semiconductor layer, a source electrode and a drain electrode formed on the ohmic contact layer, a passivation layer formed on the source electrode and the drain electrode, a flattening layer formed on the passivation layer, a first electrode formed on the flattening layer, the first electrode connected to the source electrode, an organic layer formed on the first electrode, a second electrode formed on the organic layer, a protection layer formed on the second electrode and a transparent electrode formed on the protection layer. The protection layer includes a material which is formed by an evaporation process. The protection layer includes a material that absorbs ultraviolet ray. The protection layer may include pentacene. The display device further includes a first auxiliary electrode formed on the same layer with the gate electrode using a material same with the gate electrode. The display device further includes a second auxiliary electrode formed on the same layer with the first electrode with a material same with the first electrode. The second electrode is electrically connected to the first auxiliary electrode through the second auxiliary electrode.

According to a method of forming the display device, a thin film transistor is formed on a substrate, and a first electrode is formed on the substrate having the thin film transistor. An organic layer is formed on the first electrode, and a second electrode is formed on the organic layer. A protection layer is formed on the second electrode, and a transparent layer is formed on the protection layer. The protection layer is formed by an evaporation process. The protection layer is formed by evaporating pentacene. The transparent layer is formed by a sputtering process. To form the thin film transistor, a gate electrode is formed on the display substrate, and a gate insulation layer is formed on the gate electrode. A semiconductor layer is formed on the gate insulation layer, and an ohmic contact layer is formed on the semiconductor layer. A source electrode and a drain electrode are formed on the ohmic contact layer. The method further comprises forming a passivation layer on the thin film transistor, and forming a flattening layer on the passivation layer.

The protection layer on the second electrode absorbs ultraviolet ray used in the sealing process and protects the organic layer from the ultraviolet ray. The protection layer is formed by an evaporation process and thus reduces the damage of the organic layer during formation of the protection layer. The protection layer also protects the organic layer during formation of the transparent layer.

### BRIEF DESCRIPTION OF THE DRAWINGS

FIG. 1 is an equivalent circuit diagram of a display device according to an embodiment of the present invention,

FIG. 2 is a plan view of the display device of FIG. 1.

FIG. 3 is a cross-sectional view of a pixel P in FIG. 2.

Use of the same reference symbols in different figures indicates similar or identical items.

### DETAILED DESCRIPTION OF EMBODIMENTS

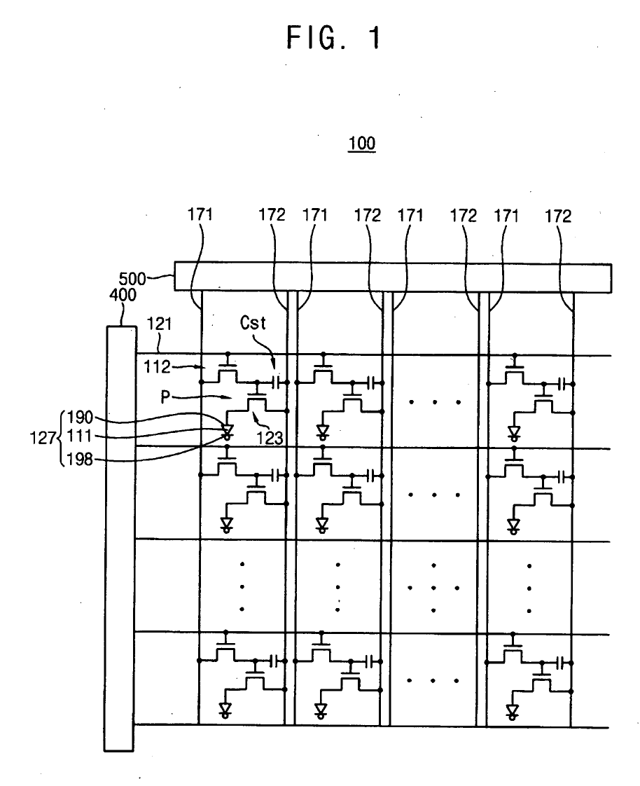

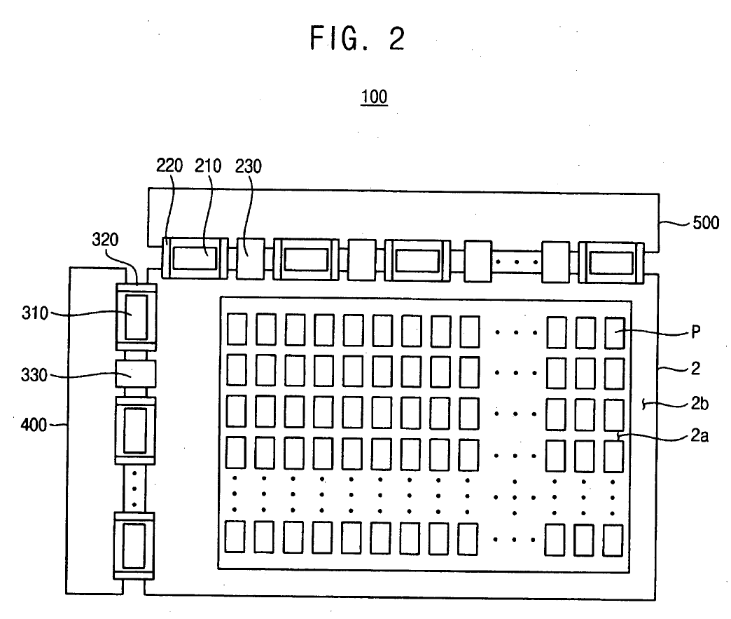

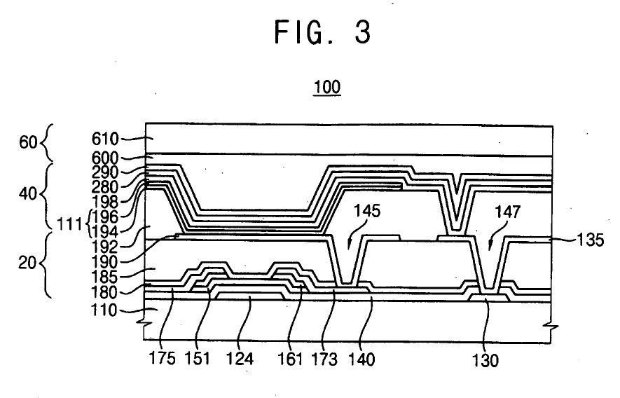

FIG. 1 is an equivalent circuit diagram of a display device 100 according to an embodiment of the present invention. FIG. 2 is a plan view of the display device 100 of FIG. 1. FIG. 3 is a cross-sectional view of a pixel P in FIG. 2.

As shown in FIG. 1, the display device 100 includes gate lines 121, data lines 171 which extend in a perpendicular direction to the gate lines 121 and power supply lines 172 which extend in parallel with the data lines 171. Pixels P are defined by the gate lines 121 and the data lines 171. A data driver circuit 500 and a gate driver circuit 400 respectively connect to the data lines 171 and the gate lines 121.

Each of pixels P includes a switching transistor 112, a storage capacitor Cst, a driving transistor 123, and a light emitting diode 127. The light emitting diode 127 includes a pixel electrode 190, a common electrode 198 and an organic layer 111 interposed between the pixel electrode 190 and the common electrode 198. The switching transistor 112 receives a gate signal from the gate driver circuit 400 via the gate line 121, and depending upon the gate signal, the storage capacitor Cst stores a data signal supplied from the data line 171 through the switching transistor 112. The data signal also runs to the gate electrode of the driving transistor 123. Then, the driving transistor 123 turns on and driving current flows from the power supply line 172 into the light emitting diode 127 through the driving transistor 123. Depending on the amount of the electric current flowing through the light emitting diode 127, the organic layer 111 illuminates.

Referring to FIGS. 1, 2 and 3, the display device 100 includes a first substrate 110, a second substrate 610 and pixels P disposed in an array form between the first substrate 110 and the second substrate 610.

The first substrate 110, which can be made of a transparent glass, is divided into a display area 2a and a non-display area 2b which is disposed outside the display area 2a. The display area 2a is composed of the pixels P.

A data integrated circuit 210 providing the data signal, a data tape carrier 220, a first flexible printed circuit board 230 providing the power supply, a gate integrated circuit 310 providing the gate signal, a gate tape carrier 320, and a second flexible printed circuit board 330 providing a common voltage are attached to or integrated on the non-display area 2b.

Referring to FIG. 3, which shows a cross-section of the display area 2a of FIG. 2, a circuit element section 20 and a light emitting element section 40 and a sealing section 60 are formed on the first substrate 110. The circuit element section 20 includes the gate line 121, the data line 171, the storage capacitor Cst, the switching transistor 112, and the driving transistor 123 which were explained previously. The sealing section 60 includes a sealing resin 600 to which the second substrate 610 attaches. The sealing resin 600 is a thermally curable resin or a photo-curable resin. In one embodiment, the sealing resin 600 is formed by an ultraviolet ray curable resin. The second substrate 610 can be a glass or a plastic.

The sealing resin 600 prevents water and/or oxygen from penetrating into the light emitting element section 40. The sealing resin 600 can be formed of an organic layer, an inorganic layer or a composite layer including an organic material and an inorganic material. The sealing resin 600 may be formed of a single layer or multiple layers.

When the sealing resin 600 includes at least two layers, the assembly process may be performed in various ways. In one embodiment, a first sealing resin is applied to the first substrate 110 on which the circuit element section 20 and the light emitting element section 40 are formed, and a second sealing resin is applied to the second substrate 610. The first substrate 110 and the second substrate 610 are assembled, and the first and second sealing resins are cured. Alternatively, in the above described method, either the first sealing resin or the second sealing resin may be semi-cured before the assembly.

In the display device 100, a portion of the light emitted from the organic layer 111 directly goes through the second substrate 610, and another portion of the light is reflected by the pixel electrode 190 and goes through the circuit element section 20 and the second substrate 610.

Referring to FIG. 3, the circuit element section 20 includes a gate electrode 124, a first auxiliary electrode 130, a gate insulating layer 140, an ohmic contact layer 161, a semiconductor layer 151, a source electrode 173, a drain electrode 175, a passivation layer 180, a flattening layer 185, a first contact hole 145, and a second contact hole 147. The gate electrode 124 can be made of aluminum (Al), molybdenum (Mo), tantalum (Ta), titanium (Ti), tungsten (W), chromium (Cr) or silver (Ag). The gate electrode 124 can have a two-layer structure. In the case, the lower film includes a low resistivity material such as Al or an Al alloy such as AlNd for reducing a signal delay or a voltage drop, and the upper film includes Mo, a Mo alloy or molybdenum nitride, which has good physical, chemical, and electrical contact characteristics with other materials such as indium tin oxide (ITO) or indium zinc oxide (IZO). A good example of the combination of the two films is a lower Al or Al alloy film and an upper Mo or Mo alloy film.

The first auxiliary electrode 130 is formed on the first substrate 110. The first auxiliary electrode 130 may be formed simultaneously with the gate electrode 124. The first auxiliary electrode 130 is connected to the common electrode 198 through a second auxiliary electrode 135.

The gate insulation layer 140 is formed on the gate electrode 124. The gate insulation layer 140 is formed of silicon oxide or silicon nitride. The semiconductor layer 151 is formed on the gate insulation layer 140. The semiconductor layer 151 may include hydrogenated amorphous silicon. The ohmic contact layer 161 is formed on the semiconductor layer 151.

The source electrode 173 and the drain electrode 175 are formed on the ohmic contact layer 161 and the gate insulating layer 140. The source electrode 173 and drain electrode 175 may have at least two layers. In one embodiment, the source electrode 173 and the drain electrode 175 have a first layer including Mo, a Mo alloy such as MoNb or molybdenum nitride, a second layer including Al or an Al alloy, and a third layer including Mo, a Mo alloy such as MoNb or molybdenum nitride. The gate electrode 124, the semiconductor layer 161, the source electrode 173 and the drain electrode 175 form a TFT. The data line 171 and the power supply line 172 are formed when the source electrode 173 and the drain electrode 175 are formed. The data line 171 is connected to the drain electrode of the switching transistor 112, and the power supply line 172 is connected to the drain electrode 175 of the driving transistor 123.

The passivation layer 180 is formed on the source electrode 173, the drain electrodes 175, and the exposed portions of the semiconductor layer 151. In one embodiment, the passivation layer 180 includes inorganic or organic insulator and may have a flat surface. Examples of the inorganic insulator include silicon nitride or silicon oxide.

The flattening layer 185 is formed on the passivation layer 180. The flattening layer 185 flattens the surface of the first substrate 110 having the above mentioned TFT. The organic layer 111 is formed on the flattened surface of the first substrate 110. The flattening layer 185 may be formed of silicon oxide or silicon nitride.

The first contact hole 145 exposing the source electrode 173 and the second contact hole 147 exposing the first auxiliary electrode 130 are formed through the gate insulation layer 140, the passivation layer 180 and the flattening layer 185. The exposed source electrode 173 is connected to the pixel electrode 190, and the exposed first auxiliary electrode 130 is connected to the common electrode 198 through the second auxiliary electrode 135.

Thus, the driving transistor 123 which is connected to each pixel electrode 190 is formed in the circuit element section 20. The above mentioned storage capacitor Cst and the switching transistor 112 are also formed in the circuit element section 20. The switching transistor 112 has a cross-sectional structure similar to that of the driving transistor 123.

Referring to FIG. 3, the light emitting element section 40 includes the organic layer 111 formed on the pixel electrode 190, a bank section 192 that partitions the organic layer 111, and a common electrode 198 formed on the organic layer 111. The pixel electrode 190, the organic layer 111 and the common electrode 198 forms a light emitting element.

The pixel electrode 190 may be formed of a reflective metal layer such as chromium (Cr), molybdenum (Mo), aluminum (Al), silver (Ag) or gold (Au) or a transparent conductive layer such as ITO or IZO. The pixel electrode 190 may include at least two layers having an upper reflective metal layer and a lower transparent conductive layer.

The second auxiliary electrode 135 can be formed simultaneously with the pixel electrode 190. The second auxiliary electrode 135 is connected to the common electrode 198 so that the common electrode 198 is connected to the first auxiliary electrode 130. The first auxiliary electrode 130 and the second auxiliary electrode 135 reduce the resistance of the common electrode 198.

The bank section 192 exposes the pixel electrodes 190. The bank section 192 may be formed of an inorganic layer such as silicon oxide (SiO₂), titanium oxide (TiO₂) by a chemical vapor deposition (CVD) process, coating process, sputtering process or evaporation process. An organic layer such as an acrylic resin or a polyimide resin may also be used for the bank section 192. The bank section 192 can have a double layer structure having a lower inorganic layer and an upper organic layer. The pixel electrode 190 and the bank section 192 are treated by plasma to activate the surfaces and adjust the work function of the pixel electrode 190.

The organic layer 111 includes a hole injection/transportation layer 194 formed on the pixel electrode 190 and an light emitting layer 196 formed on the hole injection/transportation layer 196. Other organic layers such as an electron injection/transportation layer may further be formed between the pixel electrode 190 and the common electrode 198.

The hole injection/transportation layer 194 injects and/or transports holes into the light emitting layer 196. The hole injection/transportation layer 194 improves the illumination efficiency or lifetime of the light emitting layer 196. The holes from the hole injection/transportation layer 194 and the electrons from the common electrode 198 recombine in the light emitting layer 196 to emit a light.

The light emitting layer 196 is formed on the hole injection/transportation layer 194. The light emitting layer 196 is arranged so as to emit red, green, blue or white light.

The hole injection/transportation layer 194 is formed of a mixture of polythiophene derivative such as polyethylene dioxythiophene and polystyrene sulfonic acid. The light emitting layer 196 is formed of polyfluorene derivative, (poly)p-phenylene vinylene derivative, polyphenylene derivative, polyfluorene derivative, polyvinyl carbazole, or polythiophene derivative. The above polymers can be used by doping a member such as perylene dye, coumarin dye, rhodamine dye, rubrene, perylene, 9,10-diphenylanthracene, tetraphenylbutadiene, Nile-red, coumarin 6, quinacridone.

In the forming process of the hole injection/transportation layer 194, a first composition for the hole injection/transportation layer 194 is formed on the surface of the pixel electrode 190 by using a liquid drop ejecting device such as an ink jet device. After that, a dry process and a thermal process are performed to form the hole injection/transportation layer 194.

The process of forming the hole injection/transportation layer 194 and processes thereafter are preferably conducted in an atmosphere without moisture and oxygen. An atmosphere under a nitrogen atmosphere or argon atmosphere can be used.

As the first composition, a composition made by dissolving a mixture of polythiophene derivative such as polyethylene dioxythiophene (PEDOT), and polystyrene sulfonic acid (PSS) in a polar solvent can be used. Examples of the polar solvent include, for example, isopropyl alcohol, n-butanol, γ-butyrolactone, N-methylpyrrolidone, 1,3-dimethyl-2-imidazolidinone and its derivative, glycol esters such as carbitol acetate, and butylcarbitol acetate.

More specifically, a mixture of 12.52 weight % PEDOT/PSS mixture (PEDOT/PSS=1:20), 1.44 weight % PSS, 10 weight % isopropyl alcohol, 27.48 weight % N-methylpyrrolidone and 50 weight %, 1,3-dimethyl-2-imidazolidinone can be used. The viscosity of the first composition is about 2 to 20 Ps, in particular, 4 to 15 cPs.

By using the above first composition, it is possible to perform a stable ejection operation without clogs of an ejection nozzle.

A common material for the hole injection/transportation layer 194 can be used for the red, green and blue light emitting layers 196. Alternatively, a different material can be used for each light emitting layer.

Next, a second composition is ejected on the hole injection/transportation layer 194 by the ink jet printing method. After that, the ejected composition is dried or thermally processed to form a light emitting layer 196 on the hole injection/transportation layer 194.

In the light emitting layer forming process, a non-polar solvent which is insoluble to the hole injection/transportation layer 194 is used to prevent the melting of the hole injection/transportation layer 194.

Examples of the second composition include polyfluorene derivatives, (poly)p-phenylene vinylene derivative, polyphenylene derivative, polyvinyl carbazole, polythiophene derivative, perylene dye, coumarin dye or rhodamine dye. Also an organic electroluminescent material can be doped to the above polymers. For example, rubrene, perylene, 9,10-diphenylanthracene, tetraphenylbutadiene, Nile red, coumarin 6, quinacridone can be doped to the above polymers.

Examples of the non-polar solvent insoluble to the hole injection/transportation layer 194 includes cyclohexylbenzene, dihydrobenzofuran, trimethylbenzene or tetramethylbenzene. Use of the non-polar solvent prevents the hole injection/transportation layer 194 from melting.

In this way, the hole injection/transportation layer 194 and the light emitting layers 196 are formed on the pixel electrode 190.

In this embodiment, the hole injection/transportation layer 194 and the light emitting layer 196 are formed by an ink jet printing process. The invention is not limited to the above method. The hole injection/transportation layer 194 and the light emitting layer 196 can also be formed by an evaporation process and suitable materials for the process may be used. In the evaporation process, a hole injection layer and a hole transport layer can be formed separately, and other layers such as electron injection layer, electron transport layer or blocking layer may also be formed.

The common electrode 198 is formed on an entire surface of the light emitting element section 40. The common electrode 198 is coupled with the pixel electrode 190 to flow electric current into the organic layer 111. The common electrode 198 may further include a metal layer such as calcium (Ca) or barium (Ba) that enhances the electron flow.

The common electrode 198 may be formed of multiple layers. For example, a first layer having a small work function such as calcium (Ca) and barium (Ba) is used near the light emitting layer 196. A second layer having a higher work function than the first layer such as aluminum (Al) or silver (Ag) is used near the second substrate 610. The second layer is formed by evaporation method, sputtering method or CVD method. The thickness of the second layer is in a range of about 100 to 1000 nm, in particular, about 200 to 500 nm.

A protection layer 280 may be disposed on the common electrode 198 for preventing oxidization of the common electrode 198. The protection layer 280 absorbs ultraviolet ray irradiated onto the sealing resin 600 during assembly of the first substrate 110 and the second substrate 610. The protection layer 280 also absorbs ultraviolet ray generated during sputtering of the transparent layer 290 over the protection layer 280. The protection layer 280 also absorbs physical impact imposed on the organic layer 111 during the sputtering process. A material having an enough energy band gap to absorb the ultraviolet ray may be used. Examples of such material include copper phthalocyanine, pentacene, etc. Phthalocyanine has an energy band gap of about 2.9 eV, and pentacene has an energy band gap of about 5.0 eV. A material having a higher energy band gap absorbs more energy and thus is preferred.

The protection layer 280 is often formed by an evaporation process. However, when the protection layer 280 is formed by a slit coating process, a spin coating process or a screen printing process, the common electrode 198 is exposed to air after formed in a vacuum state, so that the common electrode 198 is damaged. Thus, the display quality of the display device 100 is deteriorated. When the protection layer 280 is formed by an evaporation process which is performed under a vacuum condition, the common electrode 198 can be formed while the vacuum condition is maintained. Thus, the damage of the protection layer 280 is reduced.

A transparent layer 290 is formed on the protection layer 280. The transparent layer 290 protects the organic layer 111 and the common electrode 198 from damage by moisture and/or oxygen. The transparent layer 290 includes an inorganic material which has low permeability of moisture. Examples of the transparent layer 290 include ITO and IZO. Generally, the transparent layer 290 is formed by a sputtering process.

The second substrate 610 is bonded to the first substrate 110 by a sealing resin 600. As described above, ultraviolet ray is irradiated onto the sealing resin 600 so that the first substrate 110 and the second substrate 610 are assembled.

The assembly (sealing) process is performed in an inert gas atmosphere such as nitrogen gas, argon gas or helium gas. If the assembly process is performed in an atmosphere, moisture and/or oxygen penetrate into the common electrode 198 through a defect such as a pin hole on the common electrode 198. Thus, the common electrode 198 can be oxidized.

As described above, the protection layer on the common electrode absorbs ultraviolet ray used in the sealing process and protects the organic layer from the ultraviolet ray. The protection layer is formed by an evaporation process and thus reduces the damage of the organic layer during formation of the protection layer. The protection layer also protects the organic layer during formation of the transparent layer.

While the present invention has been described in detail with reference to the preferred embodiments, those skilled in the art will appreciate that various modifications and substitutions can be made thereto without departing from the spirit and scope of the present invention as set forth in the appended claims.

What is claimed is:

1. A display device comprising:
a substrate;
a thin film transistor formed on the substrate;
a first electrode connected to the thin film transistor;
an organic layer formed on the first electrode;
a second electrode formed on the organic layer;
a protection layer formed on the second electrode; and
a transparent layer formed on the protection layer.

2. The display device of claim 1, wherein the protection layer comprises a material formed by an evaporation process.

3. The display device of claim 1, wherein the protection layer comprises a material with an energy band gap that can absorb ultraviolet ray.

4. The display device of claim 1, wherein the protection layer comprises pentacene.

5. The display device of claim 1, wherein the second electrode transmits a light generated in the organic layer.

6. The display device of claim 1, further comprising:
a passivation layer formed between the thin film transistor and the first electrode; and
a flattening layer formed on the passivation layer.

7. The display device of claim 1, further comprising:
a sealing resin formed on the entire surface of the transparent layer; and
a sealing substrate formed on the sealing resin.

8. A display device comprising:
a substrate;
a gate electrode formed on the display substrate;
a gate insulation layer formed on the gate electrode;
a semiconductor layer formed on the gate insulation layer;
an ohmic contact layer formed on the semiconductor layer;
a source electrode and a drain electrode formed on the ohmic contact layer;
a passivation layer formed on the source electrode and the drain electrode;
a flattening layer formed on the passivation layer;
a first electrode formed on the flattening layer, the first electrode being connected to the source electrode;
an organic layer formed on the first electrode;
a second electrode formed on the organic layer;
a protection layer formed on the second electrode; and
a transparent electrode formed on the protection layer.

9. The display device of claim 8, wherein the protection layer comprises a material formed by an evaporation process.

10. The display device of claim 8, wherein the protection layer comprises a material with an energy band gap that can absorb ultraviolet ray.

11. The display device of claim 8, wherein the protection layer comprises pentacene.

12. The display device of claim 8, wherein the second electrode transmits light generated in the organic layer.

13. The display device of claim 8, further comprising:
a passivation layer formed between the thin film transistor and the first electrode; and
a flattening layer formed on the passivation layer.

14. The display device of claim 8, further comprising:
a sealing resin formed on the entire surface of the transparent layer; and
a sealing substrate formed on the sealing resin.

15. The display device of claim 8, further comprising a first auxiliary electrode formed simultaneously with the gate electrode.

16. The display device of claim 15, further comprising a second auxiliary electrode formed simultaneously with the first electrode.

17. The display device of claim 16, wherein the second electrode is electrically connected to the first auxiliary electrode through the second auxiliary electrode.

18. A method of manufacturing a display device comprising:
forming a thin film transistor on a substrate;
forming a first electrode on the substrate having the thin film transistor;
forming an organic layer on the first electrode;
forming a second electrode on the organic layer;
forming a protection layer on the second electrode; and
forming a transparent layer on the protection layer.

19. The method of claim 18, wherein forming the protection layer comprises forming the protection layer using an evaporation process.

20. The method of claim 18, wherein forming the protection layer comprises evaporating a material with an energy band gap that can absorb ultraviolet ray.

21. The method of claim 18, wherein forming the transparent layer comprises forming the transparent layer by a sputtering process.

22. The method of claim 18, wherein forming the thin film transistor comprises:
forming a gate electrode on the display substrate;
forming a gate insulation layer on the gate electrode;
forming a semiconductor layer on the gate insulation layer;
forming an ohmic contact layer on the semiconductor layer; and
forming a source electrode and a drain electrode on the ohmic contact layer.

23. The method of claim 18, further comprising:
forming a passivation layer on the thin film transistor; and forming a flattening layer on the passivation layer.
